(19) United States
(12) Patent Application Publication
(10) Pub. No.: US 2003/0172818 A1
(43) Pub. Date: Sep. 18, 2003

(54) Dampening system for a printing press

(76) Inventor: Marcel Motard, Laval (CA)

Correspondence Address: BIRCH STEWART KOLASCH & BIRCH, PO BOX 747, FALLS CHURCH, VA, 22040-0747, US

(21) Appl. No.: 10/096,274

(22) Filed: Mar. 13, 2002

(51) Int. Cl. B41L 23/00; B41L 25/00

(52) U.S. Cl. 101/148

(57) ABSTRACT

An offset printing press having a plate cylinder, a dampening unit and an inking unit. The dampening unit comprises a rotatable dampening form roller, a rotatable dampening fluid feed roller, and a rotatable auxiliary dampening roller. The rotatable dampening form roller is in removable contacting engagement with the plate cylinder along a contact stripe, and transfers dampening fluid to the plate cylinder. The rotatable dampening fluid feed roller is in removable contacting engagement with the dampening form roller and transfers dampening fluid thereto. The dampening fluid feed roller is in fluid flow communication with a dampening fluid source. The rotatable auxiliary dampening roller is in contacting engagement with the dampening form roller immediately upstream of the contact stripe.

### TECHNICAL FIELD

The present invention relates generally to offset printing presses, and more particularly to a dampening system for an offset printing press having an additional oscillating auxiliary roller.

### BACKGROUND OF THE INVENTION

Offset printing presses and their dampening units are well known in the art. Water and ink are supplied to a printing plate cylinder, and are then transferred to a blanket cylinder for printing onto sheets or web, fed between the blanket cylinder and an impression cylinder, or another blanket cylinder. The water supply portion usually comprises a dampening unit having a dampening form roller which contacts the plate cylinder and is fed water from a water pan through intermediate water transferring rollers. It is known for one or two of the intermediate rollers in contact with the dampening form roller to be axially oscillating, and provided to level the layer of water on the dampening form roller.

A structure of dampening medium and ink often builds up on the dampening form roller. Any uneven built up layer of dampening medium or ink on the dampening form roller causes the accumulation to be transferred to the plate cylinder, which correspondingly produces corduroy-like shadows on the final printed product. The oscillation of the reciprocating auxiliary rollers in contact with the dampening form roller downstream of the plate cylinder attempt to prevent this.

U.S. Pat. Nos. 5,743,183, 5,765,479 and 5,992,317 all issued to Hummel et al. on Apr. 28, 1998, Jun. 16, 1998 and Nov. 30, 1999 respectively, disclose such a dampening unit for an offset printing machine, comprising at least a first axially oscillated auxiliary roller that accepts neither dampening medium nor printing ink and is mounted in contacting relation with the dampening form roller downstream from the contact point between the dampening form roller and the plate cylinder. The first auxiliary roller can be switched from a rider of the dampening form roller, to a bridge roller positioned between the dampening form roller and an ink form roller of the ink train. A second auxiliary oscillating roller, in contact with the dampening form roller and also downstream of the contact point between the dampening form roller and the plate cylinder, can be provided. In a preferred embodiment, the second auxiliary roller is adjacent to and downstream of the contact between the first auxiliary roller and the dampening form roller.

However, as both oscillating auxiliary rollers are located downstream of the contact point between the plate cylinder and the dampening form roller, dampening fluid fed from the duct cylinder to the dampening form roller, nevertheless tends to build up on the outer surface of the dampening form roller upstream of said contact point. As a result, the two oscillating auxiliary rollers of Hummel et al. do not successfully eliminate all dampening medium build-up on the form roller, resulting in some ghosting and streaking still appearing on the printed finished product.

Depending on the application, the ability to switch the dampening unit between a set-up providing direct dampening, that is all the dampening medium is fed directly to the plate cylinder, and a set-up providing integrated dampening, wherein some of the dampening fluid is permitted to mix with the inking unit, is sometimes desirable. In the abovementioned Hummel et al. patents, the first auxiliary roller is also operable as a bridge roller, by being moved into contacting relation with the first ink applicator roller of the inking unit, in order to couple the dampening unit to the inking unit for the purposes of washing the ink applicator rollers. However, this bridging set-up is not intended for continuous printing, and although mention is made to the fact that the bridging auxiliary roller can be moved into contacting relation with the ink applicator rollers using a reciprocating mechanism, no reference is made to being able to switch between setups on the fly without having to stop the entire press.

Ikeda, in U.S. Pat. No. 5,623,873 issued Apr. 29, 1997, teaches an offset printing press that comprises a water oscillating roller having a hydrophilic property and which is axially reciprocating. Additionally, Ikeda discloses means to move the form dampening roller to and away from the plate cylinder, and means to move at least one of the water oscillating rollers and the form dampening roller to and away from each other.

Therefore, there nevertheless exists a need for an offset printing press dampening system which easily permits the dampening unit to be disconnected from the plate cylinder without losing the contact stripe between the rollers of the dampening unit, and which also permits mid-operation switching between integrated dampening printing and direct dampening printing, without requiring the entire press to be stopped. There is also a need to provide a more efficient smoothing of the dampening medium film on the dampening form roller, in order to ensure that no dampening medium build up occurs upstream of the contact point between the dampening form roller and the plate cylinder, and on the dampening form roller when the first auxiliary dampening roller is disconnected from the dampening form roller.

### SUMMARY OF THE INVENTION

It is an object of the present invention to provide an improved offset printing press dampening system.

It is another object of the present invention to provide a dampening unit comprising axially oscillating auxiliary dampening rollers in contact with a dampening form roller.

It is another object of the present invention to provide a dampening unit having a secondary oscillating auxiliary roller located upstream of the contact point between the dampening form roller and the plate cylinder.

It is yet another object of the present invention to provide a dampening unit that can be disconnected and reconnected as a whole from the ink train.

It is still another object of the present invention to provide a dampening unit that can be remotely switched between direct dampening and integrated dampening during operation without requiring stripe setting adjustments.

Therefore, in accordance with the present invention, there is provided an offset printing press comprising: a plate cylinder having a printing plate thereon; an inking unit having at least a rotatable ink applicator roller in contacting engagement with said plate cylinder for transferring ink thereto; a dampening unit for transferring dampening fluid to said plate cylinder, including a rotatable dampening fluid feed roller, a rotatable dampening form roller, and rotatable first and second auxiliary dampening rollers; said dampening form roller being in removable contacting engagement with said plate cylinder along a predetermined contact stripe for transferring dampening fluid thereto; said dampening fluid feed roller being in removable contacting engagement with said dampening form roller for transferring dampening fluid thereto; said first auxiliary dampening roller being in removable contacting engagement with said dampening form roller downstream of said contact stripe; wherein the improvement includes said dampening unit comprising a second auxiliary dampening roller in contacting engagement with said dampening form roller immediately upstream of said contact stripe; and whereby said first and second auxiliary dampening rollers are adapted to even out buildup of excess dampening fluid on said dampening form rollers such that said excess is not transferred to said plate cylinder.

There is also provided, in accordance with the present invention, an offset printing press having a plate cylinder, a dampening unit and an inking unit, the dampening unit comprising: a rotatable dampening form roller in removable contacting engagement with the plate cylinder along a contact stripe, said dampening form roller transferring dampening fluid to the plate cylinder; a rotatable dampening fluid feed roller in removable contacting engagement with said dampening form roller for transferring dampening fluid thereto; said dampening fluid feed roller being in fluid flow communication with a dampening fluid source; a rotatable auxiliary dampening roller in contacting engagement with said dampening form roller immediately upstream of said contact stripe; and whereby said auxiliary dampening roller is adapted to even out build-up of excess dampening fluid on said dampening form roller such that said excess is not transferred to said plate cylinder.

There is additionally provided, in accordance with the present invention, an offset printing press having a plate cylinder, a dampening unit and an inking unit, the dampening unit comprising: a dampening form roller in contact with the plate cylinder along a contact stripe, said dampening form roller transferring dampening fluid to the plate cylinder; an auxiliary dampening roller in exclusive contact with said dampening form roller immediately upstream of said contact stripe; whereby said auxiliary dampening roller levels build-up of excess dampening fluid on the dampening form roller such that said excess is not transferred to the plate cylinder.

### BRIEF DESCRIPTION OF THE DRAWINGS

Further features and advantages of the present invention will become apparent from the following detailed description, taken in combination with the appended drawings, in which:

FIG. 1 shows a schematic of an offset printing press having a dampening unit according to the present invention.

FIG. 2 shows a side elevation view of the dampening unit of FIG. 1.

FIG. 3a shows a schematic of an offset printing press having a dampening unit according to the present invention, wherein the dampening unit is disconnected from the plate cylinder.

FIG. 3b shows a schematic of the offset printing press of FIG. 3a, wherein the dampening unit is disconnected from the inking unit, therefore providing direct dampening of the plate cylinder.

FIG. 3c shows a schematic of the offset printing press of FIG. 3a, wherein the dampening unit is disconnected from both the inking unit and the plate cylinder.

### DETAILED DESCRIPTION OF THE PREFERRED EMBODIMENT

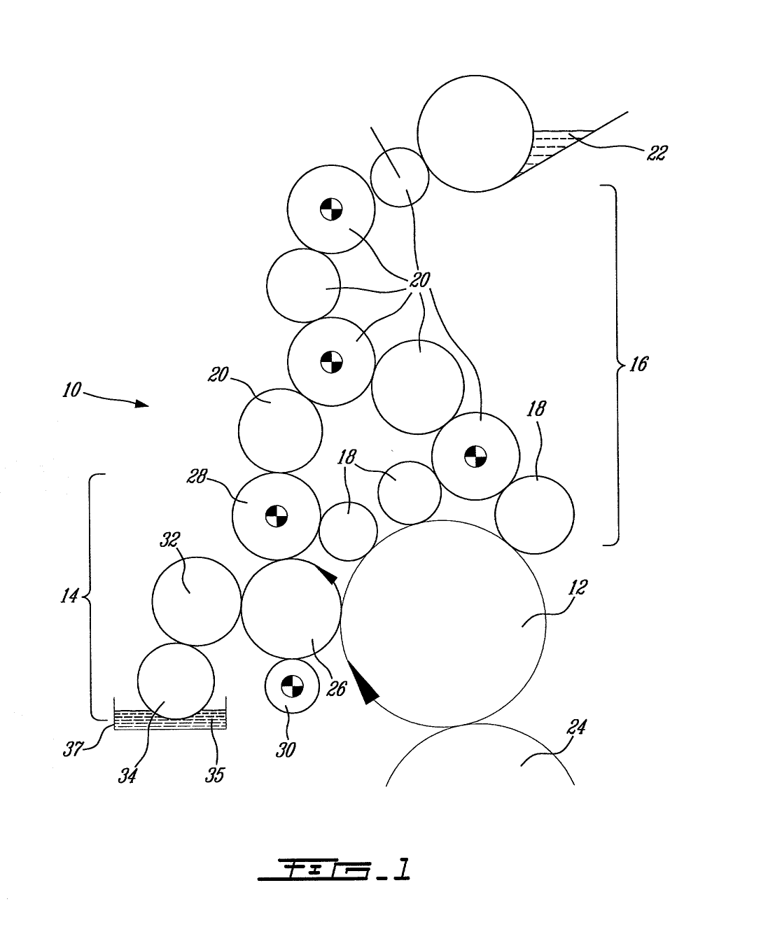

Referring to FIG. 1, partially showing an offset printing press 10 generally comprising a plate cylinder 12, a multi-roller dampening unit 14 and a multi-roller inking unit 16. Water and ink are supplied to the plate cylinder by the dampening unit 14 and inking unit 16 respectively. The water and ink are transferred from the exterior surface of the plate cylinder 12 to the blanket cylinder 24, in contacting engagement with the plate cylinder 12. Paper sheets or web are then fed between the blanket cylinder 24 and an impression cylinder or another blanket cylinder (not shown), in contacting engagement with the blanket cylinder 24. All rollers are rotatable and in precise contacting engagement with each adjacent roller along a contact stripe, such that fluid is transferred from one roller to the next. The term contact stripe is used herein to define the line of contact between two cylindrical rollers in contacting engagement. This contact stripe must be precisely set, to ensure exact and uniform contact pressure the entire length of the rollers.

Ink from the ink supply 22 is provided to the plate cylinder 12, through the inking unit train 16 comprising ink transfer rollers 20 and ink applicator rollers 18. Several ink feeding transfer rollers 20 can axially oscillate during operation in order to ensure that a smooth and constant film of ink is transferred to the plate cylinder.

The dampening fluid supply 35, contained within the dampening fluid container 37, is transferred to the plate cylinder by the multi-roller dampening unit 14, comprising a dampening fluid metering pickup roller 34 at least partially disposed within the dampening fluid container 37, at least one dampening transfer roller 32, and a dampening form roller 26 in direct contacting engagement with the plate cylinder 12. The dampening unit 14 additionally comprises a first auxiliary oscillator dampening roller 28 in removable contacting engagement with the dampening form roller 26 and located downstream of the contact point between the dampening form roller 26 and the plate cylinder 12, and additionally in contacting engagement with at least one of an ink applicator roller 18 and an ink transfer roller 20 of the inking unit 16.

A second auxiliary oscillator dampening roller 30 of the dampening unit 14 is located upstream of the contact point between the dampening form roller 26 and the plate cylinder 12, and in permanently contacting engagement with the dampening form roller 26. Both the first auxiliary dampening roller 28 and the second auxiliary roller 30 preferably axially oscillate while maintaining a precise contact stripe with the dampening form roller 26, such that any buildup of dampening fluid on the dampening form roller is leveled out and is not transferred to the plate cylinder 12. This eliminates dampening fluid ridges which can occur on the dampening form roller, that if left unlevelled, result in an excess of dampening fluid being transferred to the plate cylinder 12, which correspondingly results in shadow ridges appearing on the final printed product. The location of the second auxiliary dampening roller 30, immediately upstream of the contact stripe between the plate cylinder 12 and the dampening form roller 26, is essential and ensures fault free printing, as dampening fluid picked up by the dampening form roller 26 from the dampening transfer roller 32, downstream of the first auxiliary dampening roller 28, can cause a dampening fluid buildup on the dampening form roller 26 which cannot be leveled out by the first auxiliary oscillating dampening roller 28 before it is transferred to the plate cylinder 12.

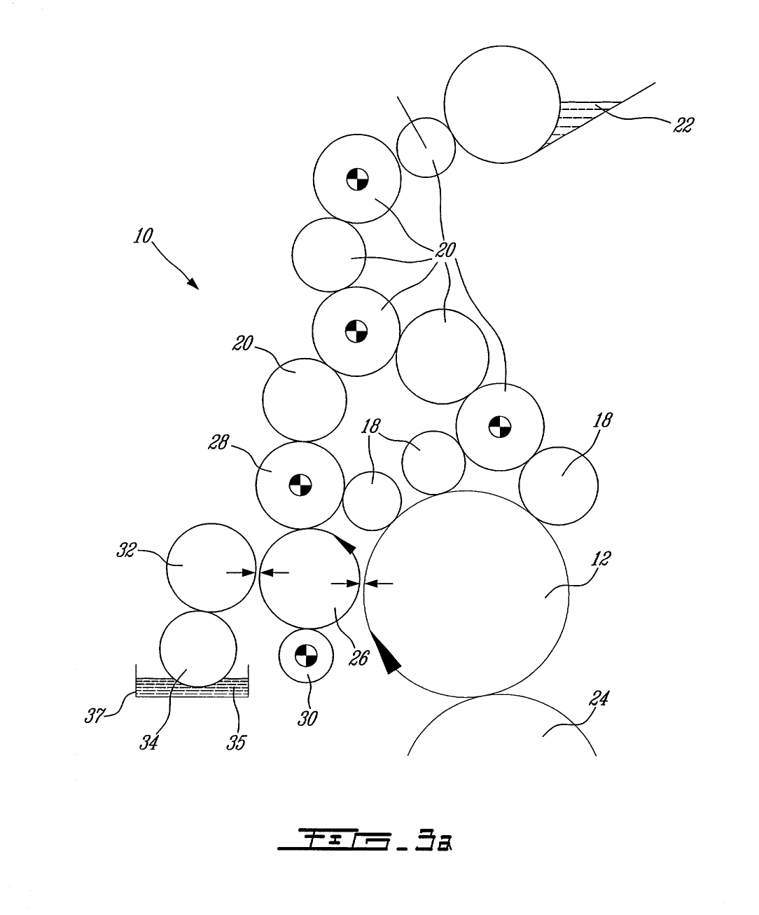

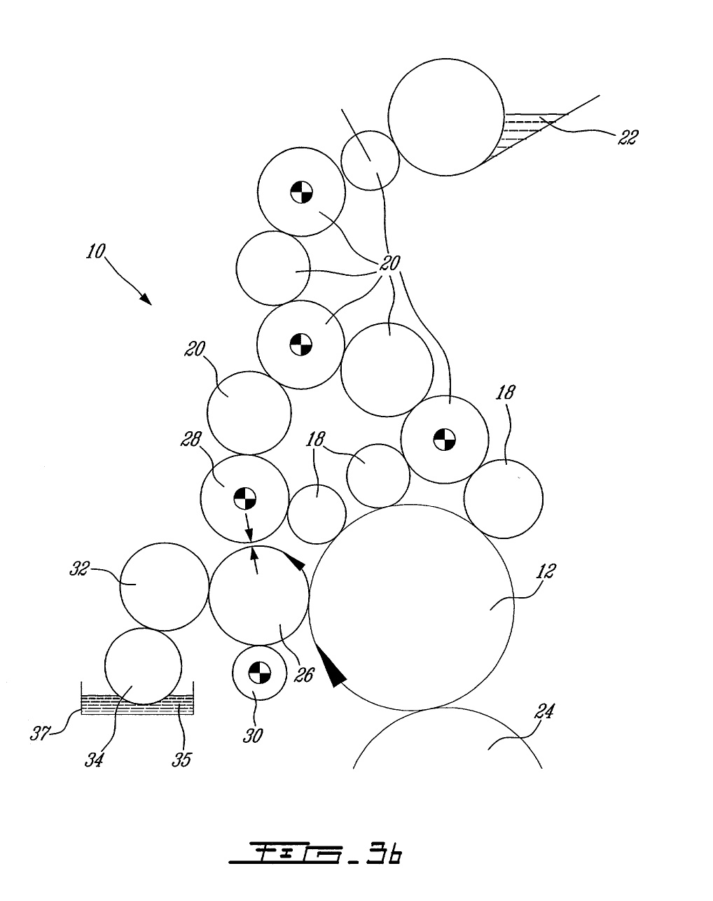

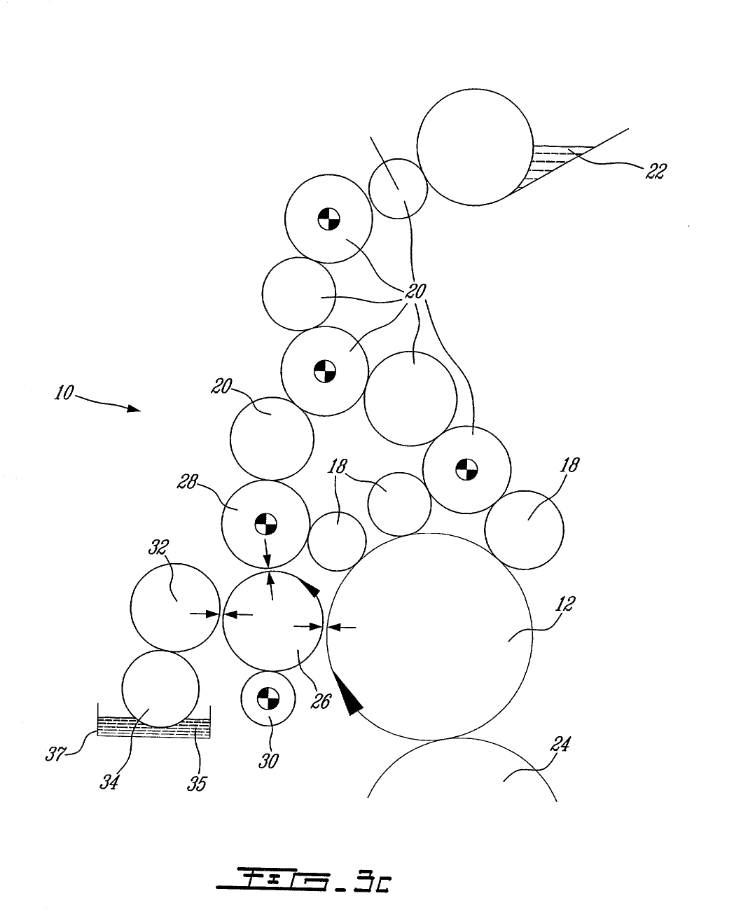

According to the present invention, the dampening form roller 26 can be disengaged from the first auxiliary dampening roller 28 in contacting engagement with the inking unit 16, allowing direct dampening of the plate cylinder 12. In this case, shown in FIG. 3b, no dampening fluid is transferred to the ink train through the first auxiliary dampening roller 28 and therefore all dampening fluid is fed directly to the plate cylinder 12. This is useful in applications requiring large surfaces of unprinted area on the final product, necessitating a significant amount of dampening fluid on the printing plate. The dampening form roller 26 can be disengaged and re-engaged from the first auxiliary dampening roller 28, without affecting the contact stripes between the dampening form roller and the other rollers contiguous therewith such as the plate cylinder, the second auxiliary dampening roller 30 and the dampening transfer roller 32. The first auxiliary dampening roller is preferably not displaced, but rather the dampening form roller and the rest of the dampening unit 14 is disengageable therefrom. As the first auxiliary dampening roller 28 is no longer in engagement with the dampening form roller 26, the oscillating second auxiliary dampening roller 30, which always remains in permanent contacting engagement with the dampening form roller 26, ensures that no dampening fluid buildup occurs on the dampening form roller and as such no excess of dampening fluid is transferred to the plate cylinder and consequently to the finished printed product.

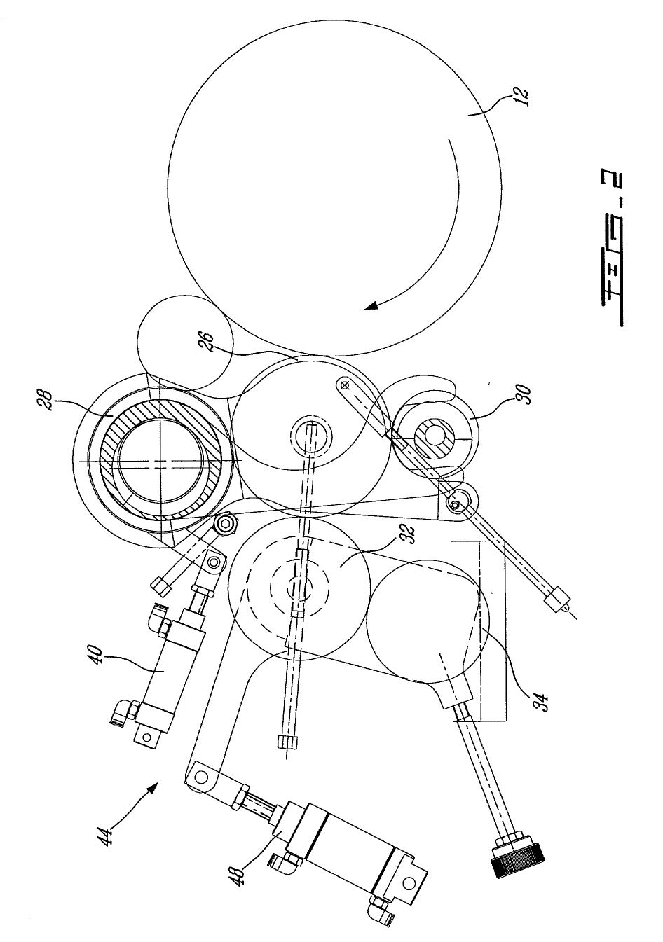

The present invention also permits the entire dampening unit 14 to be disengaged from the plate cylinder of the printing press, as shown in FIG. 3a. A remotely automated reciprocating mechanism 44, shown in FIG. 2, permits the dampening form roller 26 to be disengaged from the plate cylinder 12, and disengages the dampening transfer roller 32 from the dampening form roller, without affecting the contact stripes of both the first and second auxiliary dampening rollers. This therefore permits the dampening fluid feed to the plate cylinder to be completely stopped if required, and also permits for washing of the dampening form roller 26 and the ink train 16 if required, without danger of contaminating the dampening fluid supply 35. When re-engaged, no additional readjustment of the precise contact stripes, between the dampening form roller 26 and both the plate cylinder 12 and the dampening transfer roller 32, is required. The dampening unit disengagement mechanism 44 can be controlled either on the printing press directly or remotely by an operator.

A similar remotely automated reciprocating mechanism enables the dampening form roller to be disengaged from the first auxiliary dampening roller, as depicted in FIG. 3b, without affecting the precise contact stripe with the dampening form roller. This can also be done in combination with the disengagement of the dampening unit from the plate cylinder, and is depicted as such in FIG. 3c. These mechanisms permit the roller to be engaged and disengaged as described, without requiring the press to be stopped. This represents a huge time saving, as re-establishing precise contact stripe settings between rollers otherwise requires the press to be stopped and takes a significant amount of time. First and second hydraulic cylinders 40 and 48 serve to actuate the aforementioned reciprocating mechanisms for the first auxiliary dampening roller and dampening unit respectively.

While the mechanisms are preferably actuated by precise hydraulic or air cylinders, any other engagement and disengagement actuation means can be equivalently used, such as manually operated levers or motor driven mechanisms.

Both first and second auxiliary dampening rollers 28 and 30 are rotatable, however are not required to be circumferentially driven in order to adequately level any build up of dampening fluid. Any unwanted dampening fluid accumulated on the dampening form roller can be broken down by the axial oscillation alone of the rotating auxiliary dampening rollers, both upstream and downstream of the contact between the dampening form roller and the plate cylinder. The first oscillating dampening roller 28 preferably comprises an outer cylindrical surface made of nylon or copper, and the second oscillating dampening roller 30 preferably comprises an outer cylindrical surface made of chrome. However, any other non-stick coating, such as a polymer, can be equally used with similar effects.

The embodiment of the invention described above is intended to be exemplary only. The scope of the invention is therefore intended to be limited solely by the scope of the appended claims.

I claim:

1. An offset printing press comprising:
a plate cylinder having a printing plate thereon;
an inking unit having at least a rotatable ink applicator roller in contacting engagement with said plate cylinder for transferring ink thereto;
a dampening unit for transferring dampening fluid to said plate cylinder, including a rotatable dampening fluid feed roller, a rotatable dampening form roller, and rotatable first and second auxiliary dampening rollers;
said dampening form roller being in removable contacting engagement with said plate cylinder along a predetermined contact stripe for transferring dampening fluid thereto;
said dampening fluid feed roller being in removable contacting engagement with said dampening form roller for transferring dampening fluid thereto;
said first auxiliary dampening roller being in removable contacting engagement with said dampening form roller downstream of said contact stripe;
wherein the improvement includes said dampening unit comprising a second auxiliary dampening roller in contacting engagement with said dampening form roller immediately upstream of said contact stripe; and
whereby said first and second auxiliary dampening rollers are adapted to even out build-up of excess dampening fluid on said dampening form rollers such that said excess is not transferred to said plate cylinder.

2. The printing press as defined in claim 1, wherein said first and second auxiliary dampening rollers axially oscillate.

3. The printing press as defined in claim 1, wherein said first auxiliary dampening roller is additionally in contacting engagement with an ink carrying roller of said inking unit.

4. The printing press as defined in claim 1, wherein said dampening form roller is disengageable from said first auxiliary dampening roller while maintaining contact with said plate cylinder, and whereby said second auxiliary dampening roller continues to even out build-up of excess dampening fluid on said dampening form roller.

5. The printing press as defined in claim 4, wherein said dampening form roller is remotely disengageable and re-engageable from said first auxiliary dampening roller, without stopping the printing press and without interrupting smooth dampening fluid transfer to said plate cylinder.

6. The printing press as defined in claim 1, wherein said dampening form roller is disengageable and re-engageable from said plate cylinder, without requiring contact stripes between said dampening form roller and said first and second auxiliary dampening rollers to be readjusted.

7. The printing press as defined in claim 6, wherein said dampening form roller is disengageable from said dampening transfer roller.

8. The printing press as defined in claim 6, wherein said first auxiliary dampening roller is in contacting engagement with an ink carrying roller of said inking unit.

9. An offset printing press having a plate cylinder, a dampening unit and an inking unit, the dampening unit comprising:
a rotatable dampening form roller in removable contacting engagement with the plate cylinder along a contact stripe, said dampening form roller transferring dampening fluid to the plate cylinder;
a rotatable dampening fluid feed roller in removable contacting engagement with said dampening form roller for transferring dampening fluid thereto;
said dampening fluid feed roller being in fluid flow communication with a dampening fluid source;
a rotatable auxiliary dampening roller in contacting engagement with said dampening form roller immediately upstream of said contact stripe; and
whereby said auxiliary dampening roller is adapted to even out build-up of excess dampening fluid on said dampening form roller such that said excess is not transferred to said plate cylinder.

10. The printing press as defined in claim 9, wherein said auxiliary dampening roller axially oscillates.

11. The printing press as defined in claim 9, wherein another rotatable auxiliary dampening roller is in contacting engagement with said dampening form roller downstream of said contact point.

12. The printing press as defined in claim 11, wherein said another auxiliary dampening roller is in contacting engagement with a roller of the inking unit.

13. The printing press as defined in claim 11, wherein said dampening form roller is disengageable from said another rotatable auxiliary dampening roller by a remotely operated mechanism.

14. The printing press as defined in claim 9, wherein said dampening form roller is disengageable from the plate cylinder and said dampening fluid feed roller by a remotely operated mechanism.

15. The printing press as defined in claim 14, wherein said dampening form roller is simultaneously disengageable from the plate cylinder and said dampening fluid feed roller.

16. An offset printing press having a plate cylinder, a dampening unit and an inking unit, the dampening unit comprising:
a dampening form roller in contact with the plate cylinder along a contact stripe, said dampening form roller transferring dampening fluid to the plate cylinder;
an auxiliary dampening roller in exclusive contact with said dampening form roller immediately upstream of said contact stripe;
whereby said auxiliary dampening roller is adapted to even out build-up of excess dampening fluid on the dampening form roller such that said excess is not transferred to the plate cylinder.

17. The printing press as defined in claim 16, wherein said auxiliary dampening roller is axially oscillating.

18. The printing press as defined in claim 16, wherein said auxiliary dampening roller maintains a permanent precise contact stripe with said dampening form roller.
